(19) United States
(12) Patent Application Publication
(10) Pub. No.: US 2023/0044924 A1
(43) Pub. Date: Feb. 9, 2023

(54) A STABLE PVC COMPOSITION COMPRISING AN ENVIRONMENT-FRIENDLY PLASTICIZER

(71) Applicant: PERSTORP AB, Perstorp (SE)

(72) Inventors: Håkan BJÖRNBERG, Malmö (SE); Anders MAGNUSSON, Bjärnum (SE); Eva GUSTAVSSON, Lund (SE); Peter JOHANSSON, Vankiva (SE)

(21) Appl. No.: 17/905,539

(22) PCT Filed: Mar. 4, 2021
(86) PCT No.: PCT/SE2021/050195

§ 371 Date: Sep. 2, 2022

(30) Foreign Application Priority Data
Mar. 11, 2020 (SE) 2030074-5

(51) Int. Cl. C08F 114/06; C08K 5/11; C08K 3/014; C08K 5/00

(52) U.S. Cl. CPC C08F 114/06; C08K 3/014; C08K 5/005; C08K 5/11; C08K 2201/014

(57) ABSTRACT

The present invention refers to a polyvinyl chloride composition with high stability, said composition comprising: a) 100 phr (parts per hundred resin) of a polyvinyl chloride resin, b) 10-150 phr of pentaerythritol tetravalerate as plasticizer, said pentaerythritol tetravalerate having an acid value of less than 0.05 mg KOH/g and being obtained through esterification of valeric acid and high purity pentaerythritol having a purity of at least 98%, an ash content of less than 200 ppm and a dipentaerythritol content of 0.1-2 wt%, c) 0.3-14 phr of at least one stabilizer, and optionally d) at least one additive, wherein and the amount of free acid in the polyvinyl chloride composition is less than 30 ppm, preferably less than 20 ppm. The invention further refers to a polyvinyl chloride article comprising said composition and having an amount of free acid less than 30 ppm, preferably less than 20 ppm. The present invention also refers to a method for analyzing the amount of free acid in a polyvinyl chloride sample.

### FIELD OF THE INVENTION

The present invention refers to a polyvinyl chloride composition with high stability, comprising: a polyvinyl chloride resin; a pentaerythritol tetravalerate as plasticizer, having a low acid value and being obtained through esterification of valeric acid and high purity pentaerythritol having a low ash content and a certain dipentaerythritol content; at least one stabilizer; and optionally at least one additive, wherein and the amount of free acid in the polyvinyl chloride composition is less than 30 ppm, preferably less than 20 ppm. The present invention further refers to a polyvinyl chloride article comprising said composition and having an amount of free acid less than 30 ppm, preferably less than 20 ppm. The present invention also refers to a method of analyzing the amount of free acid in a polyvinyl chloride sample.

### BACKGROUND OF THE INVENTION

Polyvinyl chloride (PVC), is the most produced plastic polymer in the world after polyethylene and polypropylene. The polymer was discovered already in 1872 when it was observed that some vinyl chloride in a flask had started to polymerize in a white solid during exposure to the sun. However, the use of PVC in commercial products became widespread first after a method had been developed that plasticized the rigid, brittle polymer by blending PVC with several additives. The PVC polymer must always be converted into a compound by blending it with additives such as heat and UV stabilizers, flame retardants, smoke suppressants, plasticizers, processing aids, impact modifiers, thermal modifiers, pigments and fillers. The choice of additives depends on the required functionality, dictated by the application.

Plasticizers are added to PVC compositions in order to render the plastics softer, more flexible and/or more stretchable. A plasticizer needs to have a good compatibility with the polymer to be plasticized, in order to provide it with good thermoplastic properties and a low tendency to evaporation and/or exudation (high durability). Phthalic diesters with alcohols of various chemical structures have been used a lot in the past as plasticizers due to their high compatibility with PVC and because of their high performance properties, like for instance diethylhexyl phthalate (DEHP), diisononyl phthalate (DINP), and diisodecyl phthalate (DIDP). These phthalate plasticizers are however being replaced due to health risks, especially in sensitive applications, such as children’s toys, packaging for food and drinks and medical articles.

There are several known alternative PVC plasticizers, having different properties. Plasticizers which can be used as an alternative to phthalates are for instance esters, diesters and polyesters of adipic acid, succinic acid, glutaric acid, pimelic acid, suberic acid, sebacic acid, or azelaic acid, trimethylpentanediol and propylene glycol. A majority of these alternative plasticizers do however have a compatibility problem with PVC; they migrate to a considerable extent during use, which results in reduced elastic properties of the plasticized plastics produced using these plasticizers.

It is an object of the present invention to provide a PVC composition comprising a toxicologically harmless plasticizer, which has high compatibility with the PVC polymer and which as a result shows little or no tendency toward migration during use, thereby maintaining the elastic properties of the plasticized plastics produced using these plasticizers, even over prolonged periods of time.

Stabilizers are important ingredients of PVC compositions, that are added in order to allow processing of the PVC polymer and to improve its resistance against harmful effects of extreme temperature and UV radiations. There are different types of stabilizers. Heat stabilizers are among the most important stabilizers. When exposed to heat (> 100° C.), hydrochloric acid (HCl) is eliminated from the polymer backbone. The HCl then triggers a further autocatalytic degradation process, causing rapid discoloration and embrittlement of the PVC. Heat stabilizers can greatly increase the heat stability by various mechanisms, such as scavenging of released HCl molecules. A PVC composition always comprise some kind of heat stabilizer. The type of heat stabilizer that is used depends on the application and required heat stability. Lead compounds were among the first stabilizers to be adopted by the PVC industry but due to health concerns, the industry has voluntarily committed to phase out lead compounds. Other important stabilizers are antioxidants, hindered amine light stabilizers that scavenge radicals produced by weathering, UV absorbers, antiozonants that prevent degradation caused by ozone present in the atmosphere, organosulfur compounds that thermally stabilize the PVC polymer. Organic based stabilizers (OBS) are considered as a new technology providing environmentally friendly heat stabilizer for PVC compositions, substituting conventional lead stabilizer and to some extent also calcium zinc and barium zinc stabilizers.

In this patent application the term stabilizer is used both for a general purpose stabilizer, comprising no additives, and for a one-pack stabilizer, that may comprise a range of different additives. Additive is the term used for substances and mixtures that are added to the PVC composition additional to a stabilizer. Additives often have a specific function, for example hydrolytic stabilization, acid scavenging or water scavenging. The proper amount of additive depends on the nature of the stabilizer added to the same formulation and on the intended application.

There is an increasing demand of high performing non-phthalate plasticizers on the market and the ester-based plasticizer pentaerythritol tetravalerate is a perfect match to this demand. Pentaerythritol tetravalerate has a unique combination of high efficiency and low volatility, fast processing and excellent UV-stability. Pentaerythritol tetravalerate is a very stable compound on its own, but as a plasticizer in a PVC composition the stability of pentaerythritol tetravalerate can sometimes be a problem. Several factors are influencing the stability, for instance stabilizers, additives, pentaerythritol tetravalerate quality and concentration, PVC type and quality, processing parameters and humidity.

All kind of PVC grades are stabilized with so-called metal soaps. Metal soaps are derived from long-chain fatty acids and a metal oxide compound. Examples of common metal soaps are calcium stearate and zinc stearate. These metal soaps have turned out to be troublesome for ester-based plasticizers in PVC compositions. Polyester plasticizers undergo hydrolysis in the presence of metal soaps. For many polyester plasticizers this is not a big problem, but for pentaerythritol tetravalerate, releasing valeric acid upon hydrolysis, this is associated with an unpleasant odour. On top of the unpleasant odour is the smell of valeric acid detected very early, at very small amounts.

Commercial PVC stabilizers are designed to improve the stability of the polymer system, they are not designed to improve the stability of a polyester plasticizer in the polymer composition. Which makes it challenging to find stabilizers suitable to use for stabilizing the pentaerythritol tetravalerate plasticizer in a PVC compositions.

It is an object of the present invention to provide a PVC composition with high stability, comprising a pentaerythritol tetravalerate plasticizer.

The present invention also seeks to provide a PVC formulation which will reduce the carbon footprint as well as ensure superior PVC end product quality in different application areas.

### SUMMARY OF THE INVENTION

It has now been found that the above-mentioned objects are met by a PVC composition of the present invention combining a particular pentaerythritol tetravalerate plasticizer with certain stabilizers and optionally additives, creating a stable PVC composition that can be used in various applications by varying the constellation of specific stabilizers and additives.

The present invention refers to a polyvinyl chloride composition with high stability, having an amount of free acid in the polyvinyl chloride composition that is less than 30 ppm, preferably less than 20 ppm. The plasticizer in the PVC composition of the present invention is a particular pentaerythritol tetravalerate that has a low acid value and is obtained through esterification of valeric acid and high purity pentaerythritol having a low ash content and a certain dipentaerythritol content. The composition further comprises at least one stabilizer, and optionally an additive. The invention also refers to a polyvinyl chloride article comprising said composition and having an amount of free acid less than 30 ppm, preferably less than 20 ppm. Further the present invention also refers to a method of analyzing the amount of free acid in a polyvinyl chloride sample.

The pentaerythritol tetravalerate used as plasticizer in the composition of the invention is made in a way that reduces the use of finite raw material, making it a sustainable alternative among commercial plasticizers. The pentaerythritol tetravalerate of the present invention has a high content of renewable material, based on a mass balance concept. Mass balance is about mixing fossil and renewable but keeping track of their quantities and allocating them to specific products.

A wide variety of stabilizers and additives have proven to have a good compatibility with the plasticizer of the present invention. When combined with certain stabilizers, the plasticizer of the present invention has the ability to provide a superior PVC end product quality in different application areas. Great tactile properties, like high softness and flexibility and premium finish and durability in terms of less haze and improved colour clarity, superior printability, colour fastness and finish, longer lasting with lower risk of aesthetic material failure.

### DETAILED DESCRIPTION OF THE INVENTION

The present invention refers to a polyvinyl chloride composition with high stability, said composition comprising:
a) 100 phr (parts per hundred resin) of a polyvinyl chloride resin,
b) 10-150 phr of pentaerythritol tetravalerate as plasticizer, said pentaerythritol tetravalerate having an acid value of less than 0.05 mg KOH/g and being obtained through esterification of valeric acid and high purity pentaerythritol having a purity of at least 98%, an ash content of less than 200 ppm and a dipentaerythritol content of 0.1-2 wt%,
c) 0.3-14 phr of at least one stabilizer, and optionally
d) at least one additive,
wherein the amount of free acid in the polyvinyl chloride composition is less than 30 ppm, preferably less than 20 ppm and most preferably less than 10 ppm.

The plasticizer in the present invention could also be used together with other polymers which are processed with plasticizers, like vinyl chloride-based copolymers, polyvinylidene chloride, polyvinyl acetate, polyvinyl butyral, polyacrylates, polyamides, polylactides, polyurethane, cellulose and derivatives thereof and rubber polymers. The present invention is however focusing on polyvinyl chloride (PVC).

PVC is obtained by homopolymerization of vinyl chloride. The PVC used in accordance with the invention a) may be prepared, for example, by suspension polymerization, microsuspension polymerization, emulsion polymerization, or bulk polymerization. Preferably the PVC is prepared by suspension polymerization (S-PVC) or emulsion polymerization (E-PVC). The polyvinyl chloride used in the present invention is preferably a commercial polymer. S-PVC accounts for more than 80% of the PVC market and is used for all kinds soft plastic items, tubes and rigid plastic profiles. E-PVC has smaller grain size and is typically used to produce plastic flooring, faux leather or faux wallpaper etc.

The PVC composition according to the invention may be mixed as a dry blend, or liquid mixture or paste, and may be processed further after additional processing to granules. Examples of different processing operations are extruding, injection molding, spraying, calendaring, rotational molding, dipping, spreading, coating, sintering and casting.

The plasticizer in the composition of the present invention, pentaerythritol tetravalerate b) is preferably present in amounts of 20-50 phr. Said pentaerythritol tetravalerate is obtained through esterification of valeric acid and high purity pentaerythritol having a purity of at least 98%, an ash content of less than 200 ppm, preferably less than 100 ppm and most preferably less than 50 ppm. The pentaerythritol tetravalerate plasticizer in the composition of the present invention can be included in the range of products commercially known as Pevalen™.

The plasticizer of the present invention is a general purpose plasticizer, but is especially suitable for close contact PVC applications, such as coated textiles, contact/design films and automotive interiors. The pentaerythritol tetravalerate plasticizer in the composition of the present invention contributes to great properties in S-PVC, especially regarding hardness, volatility, blend time, UV-stability, extraction water solutions and good migration to rubber and extraction chemicals and oils. When used in a plastisol the pentaerythritol tetravalerate uniquely enables both low viscosity and fast gelation, and contributes to low fogging properties.

The plasticizer of the present invention, pentaerythritol tetravalerate, is a very stable compound on its own, but as a plasticizer in a PVC composition the stability of pentaerythritol tetravalerate can sometimes be a problem. Several factors are influencing the stability, for instance stabilizers, additives, pentaerythritol tetravalerate quality and concentration, PVC type and quality, processing parameters and humidity.

Already at the low amount of 0.003 mg/m³ the smell of valeric acid is detected. When compared to 2-ethylhexanol, released upon hydrolysis of diethylhexyl phthalate (DEHP) and isodecanol, released upon hydrolysis of diisodecyl phthalate (DIDP), they start to smell at amounts of 0.4 mg/m³ and 0.1 mg/m³, respectively and their odours are not unpleasant.

It is a challenge to analyze such small amounts of valeric acid. For this purpose a new analysis method to monitor the hydrolytic stability of the plasticizer of the present invention has been developed. This method includes a reliable method based on Liquid Chromatography (LC) where the amount of valeric acid in a PVC film is quantified by LC after derivatization of the acid to an amide, through reaction with a carbodiimide and an amine. The valeric acid analysis method is further described in Example 7.

It is not easy to foresee what PVC stabilizers are suitable to use together with pentaerythritol tetravalerate. Some PVC stabilizers have shown to have a tendency to decompose/hydrolyse pentaerythritol tetravalerate. After some extensive testing certain stabilizers have been found to work well in PVC formulations with the plasticizer of the present invention. It has also been found that the use of certain additives can increase the stability of pentaerythritol tetravalerate in PVC compositions.

In some embodiments of the present invention the addition of an additive d) has the effect of reducing the degradation of the plasticizer, pentaerythritol tetravalerate b), a degradation induced by the presence of a stabilizer c). For instance has the addition of an overbased additive shown to generally have a very positive effect on the performance of both liquid and solid Ca/Zn stabilizers, as well as for Ba/Zn stabilizers, regarding the stability of pentaerythritol tetravalerate in a PVC composition. Especially the process stability and the storage stability are increased with the presence of an overbased additive. A suitable amount of additive is in the range of 0-2 phr, preferably 0.25-1 phr, depending on the amount of valeric acid released in the corresponding PVC composition with only stabilizer.

The chemistry involved in the interaction between the different components in a PVC composition is rather complex and sometimes unpredictable. Although liquid Ca/Zn stabilizers have shown to contribute to a high process stability, solid Ca/Zn stabilizers does not work at all, at least not alone. The addition of a certain additive has shown to play an essential part in situations where the stabilizer has an hydrolysing effect on the plasticizer of the present invention. A combination of stabilizer and additive can work miracles in terms of stabilizing the plasticizer of the present invention in a PVC composition. The combination of a Ca overbased additive and a solid Ca/Zn stabilizer has for instance shown to counteract the hydrolysing effect of the solid Ca/Zn stabilizer on the plasticizer of the present invention and increase the process stability. Solid Ca/Zn stabilizers are suitable in low amounts in PVC formulations for food contact applications. Stabilizers comprising tin (Sn) have shown to have a very low compatibility with pentaerythritol tetravalerate. Through extensive testing and analyzing it has been realized which stabilizers works well with the plasticizer of the present invention and which does not. The amount of stabilizer in the composition of the present invention is preferably 1-6 phr.

In order to reach a PVC composition of the present invention, having a high process stability, suitable stabilizers c) are selected from the group consisting of liquid Ba/Zn, liquid Ca/Zn, solid Ca/Zn, liquid organic based (OBS) and solid organic based (OBS). A composition according to the present invention is classified as having a high process stability when not more than 30 ppm of acid is leaving the composition during processing. Suitable additives d) that contribute to high process stability are selected from the group consisting of carbodiimide, epoxidized soybean oil (ESO), epoxidized linseed oil (ELO), amine, preferably a tertiary amine, phosphite, overbased carboxylate, overbased sulfonate, overbased phosphonate, overbased salicylate or overbased phenate including Ca, Ba or Mg, preferably overbased calcium carboxylate, overbased barium carboxylate, overbased magnesium alkyl salicylate and overbased calcium sulfonate, oxazolidine, zeolite, hydrotalcite, calcium oxide and calcium hydroxide.

Particularly preferred stabilizers that have shown good compatibility with the plasticizer of the present invention and that contribute to a PVC composition with high process stability are listed in the table below. Over hundreds of different stabilizers have been screened in order to arrive at this preferred list of stabilizers.

| | | | |
|---|---|---|---|
| Trademark | Type | Form | Supplier |
| Lankromark™ LZB985 | Ba/Zn | Liquid | Valtris Specialty Chemicals |
| Lankromark™ LZB1150 | Ba/Zn | Liquid | Valtris Specialty Chemicals |
| Reagens SLX/782 F | Ba/Zn | Liquid | Reagens |
| Mark® 4825 | Ba/Zn | Liquid | Galata Chemicals |
| Reagens SL/326 | Ba/Zn | Liquid | Reagens |
| Reagens SLX/781 | Ba/Zn | Liquid | Reagens |
| Lastab™ DE565 | Ba/Zn | Liquid | Valtris Specialty Chemicals |
| Reagens SLX/782 | Ba/Zn | Liquid | Reagens |
| Reagens SLX 791 | Ba/Zn | Liquid | Reagens |
| Baerostab UBZ 780 RF | Ba/Zn | Liquid | Baerlocher |
| Mark® BZ 961 | Ba/Zn | Liquid | Galata Chemicals |
| Baerostab UBZ 711-1 X RF | Ba/Zn | Liquid | Baerlocher |
| Baerostab UBZ 751 RF | Ba/Zn | Liquid | Baerlocher |
| Mark® BZ 855 | Ba/Zn | Liquid | Galata Chemicals |
| Baerostab UBZ 711-3 X RF | Ba/Zn | Liquid | Baerlocher |
| Reagens SLX/981/2 PF | Ba/Zn | Liquid | Reagens |
| Reagens SL/338 | Ba/Zn | Liquid | Reagens |
| Baerostab MC 8763-3 | Ba/Zn | Liquid | Reagens |
| TS 389 | Ba/Zn | Liquid | AM Stabilizers |
| TS 221 | Ca/Zn | Liquid | AM Stabilizers |
| Lastab™ CF419 | Ca/Zn | Liquid | Valtris Specialty Chemicals |
| Lastab™ CF375T | Ca/Zn | Liquid | Valtris Specialty Chemicals |
| Reagens CL/355 | Ca/Zn | Liquid | Reagens |
| Reagens CL/358 | Ca/Zn | Liquid | Reagens |
| Reagens SLX/768 | Ca/Zn | Liquid | Reagens |
| Baerostab UBZ 729-1 SRF | Ca/Zn | Liquid | Baerlocher |
| Mark® 2181 | Ca/Zn | Liquid | Valtris Specialty Chemicals |
| Lankromark™ LZB578 | Ca/Zn | Liquid | Valtris Specialty Chemicals |
| Lankromark™ LZB1106 | Ca/Zn | Liquid | Valtris Specialty Chemicals |
| Interlite™ ZX9127 | Ca/Zn | Paste | Valtris Specialty Chemicals |
| Interlite™ ZP9623 | Ca/Zn | Solid | Valtris Specialty Chemicals |
| Baeropan R 8703 KA/20 | Ca/Zn | Solid | Baerlocher |
| Baeropan R 8703 KA/5 | Ca/Zn | Solid | Baerlocher |
| Naftosafe® C CP 85111 | Ca/Zn | Solid | Chemson |
| Mark® 6092 ACM | Mg/Zn | Solid | Galata Chemicals |
| Baerostab MOE 11062 | Ba/Zn | Liquid | Baerlocher |
| Mark® OBS 2405 | OBS | Liquid | Galata Chemicals |
| Mark® OBS 1200 | OBS | Liquid | Galata Chemicals |
| Baerostab NT MZ 5S | OBS | Liquid | Baerlocher |
| TS 587 | OBS | Solid | AM Stabilizers |
| Naftosafe® PXX 30152-01 | OBS | Solid | Chemson |
| Naftosafe® HFP 86871 | OBS | Solid | Chemson |
| Reapak B-NT/7056/3 X | OBS | Solid | Reagens |
| Mark® OBS 705 | OBS | Solid | Galata Chemicals |
| Naftosafe® 30152 | OBS | Solid | Chemson |
| Baerostab MC 90163-1 CP | OBS | Solid | Baerlocher |
| Baerostab UBZ 711-1 X RF | Ba/Zn | Liquid | Baerlocher |
| Ackrostab™LZB 6148 | OBS | Solid | Valtris Specialty Chemicals |
| Lankromark™ LZB996 | OBS | Solid | Valtris Specialty Chemicals |
| Baerostab UBZ 751 | OBS | Solid | Baerlocher |
| TS 587 | OBS | Solid | AM Stabilizers |
| TS 588 | OBS | Solid | AM Stabilizers |

In order to reach a PVC composition of the present invention, having a high storage stability, suitable stabilizers c) are selected from the group consisting of liquid Ba/Zn, liquid Ca/Zn, solid Ca/Zn, liquid organic based (OBS), solid organic based (OBS) and solid Mg/Zn. A composition according to the present invention is classified as having a high storage stability when the concentration of free acid is not increasing more than 15 ppm during 6 months of storage.

Suitable additives d) that contribute to high storage stability are selected from the group consisting of carbodiimide, polymeric primary epoxide, overbased carboxylate, overbased sulfonate, overbased phosphonate, overbased salicylate or overbased phenate including Ca, Ba or Mg, preferably overbased calcium carboxylate, overbased barium carboxylate, overbased magnesium alkyl salicylate and overbased calcium sulfonate, zeolite, hydrotalcite, calcium oxide and calcium hydroxide.

Particularly preferred stabilizers that have shown good compatibility with the plasticizer of the present invention and that contribute to a PVC composition with high storage stability are listed in the table below.

| | | | |
|---|---|---|---|
| Trademark | Type | Form | Supplier |
| Naftosafe® PXX 30152-01 | OBS | Solid | Chemson |
| Naftosafe®HFP 86871 | OBS | Solid | Chemson |
| Mark® OBS 2405 | OBS | Liquid | Galata Chemicals |
| Reapak B-NT/7056/3 X | OBS | Solid | Reagens |
| TS 221 | Ca/Zn | Liquid | AM Stabilizers |
| Mark® OBS 705 | OBS | Solid | Galata Chemicals |
| Baerostab NT580 A | Ca/Zn | Solid | Baerlocher |
| Reapak B-NT/8083/2 M | Ca/Zn | Solid | Reagens |
| Lastab™ CF419 | Ca/Zn | Liquid | Valtris Specialty Chemicals |
| Lankromark™ LZB985 | Ba/Zn | Liquid | Valtris Specialty Chemicals |
| Lankromark™ LZB1150 | Ba/Zn | Liquid | Valtris Specialty Chemicals |
| Reagens SLX 782 F | Ba/Zn | Liquid | Reagens |
| Baerostab NT170 PS | Ca/Zn | Paste | Baerlocher |
| Reapak B-NT/8083/2 M | Ca/Zn | Solid | Reagens |
| Lastab™ CF375T | Ca/Zn | Liquid | Valtris Specialty Chemicals |
| Mark® 4825 | Ba/Zn | Liquid | Galata Chemicals |
| Mark® 6092 ACM | Mg/Zn | Solid | Galata Chemicals |
| Interlite™ ZP9623 | Ca/Zn | Solid | Valtris Specialty Chemicals |
| Naftosafe® 4774-07 | Ca/Zn | Solid | Chemson |
| Reagens SL/326 | Ba/Zn | Liquid | Reagens |
| Reagens SLX/781 | Ba/Zn | Liquid | Reagens |
| Interlite™ ZP9600 | Ca/Zn | Solid | Valtris Specialty Chemicals |
| Mark® CZ 2053 | Ca/Zn | Solid | Galata Chemicals |
| Lastab™ DE565 | Ba/Zn | Liquid | Valtris Specialty Chemicals |
| Mark® CZ 2053 | Ca/Zn | Solid | Galata Chemicals |
| Mark® CZ 2051 | Ca/Zn | Solid | Galata Chemicals |
| Baeropan R 8703 KA/20 | Ca/Zn | Solid | Baerlocher |
| Baeropan R 8703 KA/5 | Ca/Zn | Solid | Baerlocher |
| TS 588 | OBS | Solid | AM Stabilizers |
| Naftosafe® 30152 | OBS | Solid | Chemson |
| Reagens SLX/782 | Ba/Zn | Liquid | Reagens |
| TS 389 | Ba/Zn | Liquid | AM Stabilizers |
| Reagens SLX/791 | Ba/Zn | Liquid | Reagens |
| Baerostab NT MZ 55 | Ca/Zn | Solid | Baerlocher |
| Lastab™ DC2040S | Ba/Zn | Liquid | Valtris Specialty Chemicals |
| Lastab™ CE706PF | Ca/Zn | Liquid | Valtris Specialty Chemicals |
| Baerostab MC 9308 EP | Ca/Zn | Solid | Baerlocher |
| Naftosafe® CZP 4774-07 | Ca/Zn | Solid | Chemson |
| Naftosafe® CZP 97801 | Ca/Zn | Solid | Chemson |
| Reapak B-NT/8104M | Ca/Zn | Solid | Reagens |

In order to reach a PVC composition of the present invention, having a high hydrolytic stability, suitable stabilizers c) are selected from the group consisting of liquid Ba/Zn, liquid Ca/Zn, solid Ca/Zn, paste Ca/Zn, liquid organic based (OBS) and solid organic based (OBS). A composition according to the present invention is classified as having a high hydrolytic stability when the concentration of free acid is not more than 150 ppm after 3 weeks of exposure to near 100% RH and 50° C. Suitable additives d) that contribute to high hydrolytic stability are carbodiimides, polymeric primary epoxides and/or zeolites.

Particularly preferred stabilizers that have shown good compatibility with the plasticizer of the present invention and that contribute to a PVC composition with high hydrolytic stability are listed in the table below.

| | | | |
|---|---|---|---|
| Trademark | Type | Form | Supplier |
| Naftosafe® PXX 30152-01 | OBS | Solid | Chemson |
| Naftosafe® HFP 86871 | OBS | Solid | Chemson |
| Mark® OBS 2405 | OBS | Liquid | Galata Chemicals |
| Reapak B-NT/7056/3 X | OBS | Solid | Reagens |
| TS 221 | Ca/Zn | Liquid | AM Stabilizers |
| Mark® OBS 2405 | OBS | Liquid | Galata Chemicals |
| Mark® OBS 705 | OBS | Solid | Galata Chemicals |
| Interlite™ ZX9127 | Ca/Zn | Paste | Valtris Specialty Chemicals |
| Baerostab NT580 A | Ca/Zn | Solid | Baerlocher |
| Reapak B-NT/8083/2 M | Ca/Zn | Solid | Reagens |
| Lastab™ CF419 | Ca/Zn | Liquid | Valtris Specialty Chemicals |
| Lankromark™ LZB985 | Ba/Zn | Liquid | Valtris Specialty Chemicals |
| Interlite™ ZX9004 | Ca/Zn | Paste | Valtris Specialty Chemicals |
| TS 587 | OBS | Solid | AM Stabilizers |
| Lankromark™ LZB1150 | Ba/Zn | Liquid | Valtris Specialty Chemicals |
| TS 588 | OBS | Solid | AM Stabilizers |
| Reagens SLX/782 F | Ba/Zn | Liquid | Reagens |
| Baerostab NT170 PS | Ca/Zn | Paste | Baerlocher |
| Reapak B-NT/8083/2 M | Ca/Zn | Solid | Reagens |
| Lastab™ CF375T | Ca/Zn | Liquid | Valtris |
| Mark® 4825 | Ba/Zn | Liquid | Galata Chemicals |

In order to reach a PVC composition of the present invention, having a combination of high process stability and high storage stability, suitable stabilizers c) are selected from the group consisting of liquid Ba/Zn, liquid Ca/Zn, solid Ca/Zn, solid Mg/Zn, liquid organic based (OBS) and solid organic based (OBS). Suitable additives d) that contribute to a combination of high process stability and high storage stability are selected from the group consisting of carbodiimide, overbased carboxylate, overbased sulfonate, overbased phosphonate, overbased salicylate or overbased phenate including Ca, Ba or Mg, preferably overbased calcium carboxylate, overbased barium carboxylate, overbased magnesium alkyl salicylate and overbased calcium sulfonate and zeolite.

Particularly preferred stabilizers that have shown good compatibility with the plasticizer of the present invention and that contribute to a PVC composition with a combination of high process stability and high storage stability are listed in the table below.

| | | | |
|---|---|---|---|
| Trademark | Type | Form | Supplier |
| Lankromark™ LZB985 | Ba/Zn | Liquid | Valtris Specialty Chemicals |
| Lankromark™ LZB1150 | Ba/Zn | Liquid | Valtris Specialty Chemicals |
| Reagens SLX 782 F | Ba/Zn | Liquid | Reagens |
| Mark® 4825 | Ba/Zn | Liquid | Galata Chemicals |
| Reagens SL/326 | Ba/Zn | Liquid | Reagens |
| Reagens SLX/781 | Ba/Zn | Liquid | Reagens |
| Lastab™ DE565 | Ba/Zn | Liquid | Valtris Specialty Chemicals |
| Reagens SLX 782 | Ba/Zn | Liquid | Reagens |
| Reagens SLX/791 | Ba/Zn | Liquid | Reagens |
| TS 389 | Ba/Zn | Liquid | AM Stabilizers |
| TS 221 | Ca/Zn | Liquid | AM Stabilizers |
| Lastab™ CF419 | Ca/Zn | Liquid | Valtris Specialty Chemicals |
| Lastab™ CF375T | Ca/Zn | Liquid | Valtris Specialty Chemicals |
| Interlite™ ZP9623 | Ca/Zn | Solid | Valtris Specialty Chemicals |
| Baeropan R 8703 KA/20 | Ca/Zn | Solid | Baerlocher |
| Baeropan R 8703 KA/5 | Ca/Zn | Solid | Baerlocher |
| Mark® 6092 ACM | Mg/Zn | Solid | Galata Chemicals |
| Mark® OBS 2405 | OBS | Liquid | Galata Chemicals |
| Naftosafe® PXX 30152-01 | OBS | Solid | Chemson |
| Naftosafe® HFP 86871 | OBS | Solid | Chemson |
| Reapak B-NT/7056/3 X | OBS | Solid | Reagens |
| Mark® OBS 705 | OBS | Solid | Galata Chemicals |
| TS 588 | OBS | Solid | AM Stabilizers |
| Naftosafe® 30152 | OBS | Solid | Chemson |

In order to reach a PVC composition of the present invention, having a combination of high process stability, high storage stability and high hydrolytic stability, suitable stabilizers c) are selected from the group consisting of liquid Ba/Zn, liquid Ca/Zn, liquid organic based and solid organic based stabilizer. Suitable additives d) that contribute to a combination of high process stability, high storage stability and high hydrolytic stability are carbodiimides, polymeric primary epoxides and/or zeolites.

Particularly preferred stabilizers that have shown good compatibility with the plasticizer of the present invention and that contribute to a PVC composition with a combination of high process stability, high storage stability and high hydrolytic stability are listed in the table below.

| | | | |
|---|---|---|---|
| Trademark | Type | Form | Supplier |
| Lankromark™ LZB985 | Ba/Zn | Liquid | Valtris Specialty Chemicals |
| Lankromark™ LZB1150 | Ba/Zn | Liquid | Valtris Specialty Chemicals |
| Reagens SLX 782 F | Ba/Zn | Liquid | Reagens |
| Mark® 4825 | Ba/Zn | Liquid | Galata Chemicals |
| TS 221 | Ca/Zn | Liquid | AM Stabilizers |
| Lastab™ CF419 | Ca/Zn | Liquid | Valtris Specialty Chemicals |
| Lastab™ CF375T | Ca/Zn | Liquid | Valtris Specialty Chemicals |
| Mark® OBS 2405 | OBS | Liquid | Galata Chemicals |
| Naftosafe® PXX 30152-01 | OBS | Solid | Chemson |
| Naftosafe® HFP 86871 | OBS | Solid | Chemson |
| Reapak B-NT/7056/3 X | OBS | Solid | Reagens |

In a preferred embodiment of the present invention the polyvinyl chloride resin a) is a polyvinyl chloride suspension resin (S-PVC) and suitable stabilizers c) are selected from the group consisting of liquid Ba/Zn, solid Ca/Zn and liquid calcium organic based stabilizer.

Particularly preferred stabilizers that have shown good compatibility with the plasticizer of the present invention in a S-PVC are listed in the table below.

| | | | |
|---|---|---|---|
| Trademark | Type | Form | Supplier |
| Mark® 4825 | Ba/Zn | Liquid | Galata Chemicals |
| Lankromark™ LZB1150 | Ba/Zn | Liquid | Valtris Specialty Chemicals |
| TS 510 with TS 511 | Ba/Zn | Liquid | AM Stabilizers |
| Baerostab NT MZ 5S | Ca/Zn | Solid | Baerlocher |
| Naftosafe® PXX 30152 | OBS | Solid | Chemson |
| Naftosafe® HFP 86871 | OBS | Solid | Chemson |
| Reapak B-NT/7056 3X | OBS | Solid | Reagens |
| TS 588 | OBS | Solid | AM Stabilizers |
| Reagens SL/326 | Ba/Zn | Liquid | Reagens |
| Reagens SLX/781 | Ba/Zn | Liquid | Reagens |
| Reagens SLX/782 F | Ba/Zn | Liquid | Reagens |
| Mark® 6092 ACM | Mg/Zn | Solid | Galata Chemicals |
| Mark® OBS 2405 | OBS | Liquid | Galata Chemicals |

In an embodiment of the present invention the polyvinyl chloride resin a) is a S-PVC and in order to reach a PVC composition having a high process stability in calendaring, suitable stabilizers c) are then selected from the group consisting of liquid Ba/Zn, solid Mg/Zn and liquid calcium organic based stabilizer.

Particularly preferred stabilizers that have shown good compatibility with the plasticizer of the present invention in a S-PVC for use in calendaring are listed in the table below.

| | | | |
|---|---|---|---|
| Trademark | Type | Form | Supplier |
| Reagens SL/326 | Ba/Zn | Liquid | Reagens |
| Reagens SLX/781 | Ba/Zn | Liquid | Reagens |
| Reagens SLX/782 F | Ba/Zn | Liquid | Reagens |
| Mark® 6092 ACM | Mg/Zn | Solid | Galata Chemicals |
| Naftosafe® PXX 30152 | OBS | Solid | Chemson |
| Naftosafe® HFP 86871 | OBS | Solid | Chemson |
| Mark® OBS 2405 | OBS | Liquid | Galata Chemicals |
| Lankromark™ LZB1150 | Ba/Zn | Liquid | Valtris Specialty Chemicals |

In an embodiment of the present invention the polyvinyl chloride resin a) is a S-PVC and in order to reach a PVC composition having a high process stability in extrusion, suitable stabilizers c) are liquid Ba/Zn, and/or liquid calcium organic based stabilizer.

Particularly preferred stabilizers that have shown good compatibility with the plasticizer of the present invention in a S-PVC for use in extrusion are listed in the table below.

| | | | |
|---|---|---|---|
| Trademark | Type | Form | Supplier |
| Mark® 4825 | Ba/Zn | Liquid | Galata Chemicals |
| Reagens SLX/782 F | Ba/Zn | Liquid | Reagens |
| Mark® OBS 2405 | OBS | Liquid | Galata Chemicals |
| Lankromark™ LZB1150 | Ba/Zn | Liquid | Valtris Specialty Chemicals |

In an embodiment of the present invention the polyvinyl chloride resin a) is a S-PVC and in order to reach a PVC composition having a high process stability in injection molding, suitable stabilizers c) are liquid Ba/Zn, and/or liquid calcium organic based stabilizer.

Particularly preferred stabilizers that have shown good compatibility with the plasticizer of the present invention in a S-PVC for use in injection molding are listed in the table below.

| | | | |
|---|---|---|---|
| Trademark | Type | Form | Supplier |
| Reagens SLX/782 F | Ba/Zn | Liquid | Reagens |
| Lankromark™ LZB1150 | Ba/Zn | Liquid | Valtris Specialty Chemicals |

In another preferred embodiment of the present invention the polyvinyl chloride resin a) is a polyvinyl chloride emulsion resin (E-PVC) and suitable stabilizers c) are selected from the group consisting of liquid Ba/Zn, liquid Ca/Zn and liquid calcium organic based stabilizer.

Particularly preferred stabilizers that have shown good compatibility with the plasticizer of the present invention in a plastisol made from E-PVC are listed in the table below.

| | | | |
|---|---|---|---|
| Trademark | Type | Form | Supplier |
| Mark® 4825 | Ba/Zn | Liquid | Galata Chemicals |
| Reagens SLX/782 F | Ba/Zn | Liquid | Reagens |
| Lankromark™ LZB1150 | Ba/Zn | Liquid | Valtris Specialty Chemicals |
| TS 221 | Ca/Zn | Liquid | AM Stabilizers |
| Lastab™ CF 419 | Ca/Zn | Liquid | Valtris Specialty Chemicals |
| TS 510 with TS 511 | Ba/Zn | Liquid | AM Stabilizers |
| Naftosafe® PXX 30152 | OBS | Solid | Chemson |
| Naftosafe® HFP 86871 | OBS | Solid | Chemson |
| Mark® OBS 2405 | OBS | Liquid | Galata Chemicals |
| TS 588 | OBS | Solid | AM Stabilizers |

In an embodiment of the present invention the polyvinyl chloride resin a) is an E-PVC and in order to reach a PVC composition having a high process stability in coating, suitable stabilizers c) are then liquid Ba/Zn and/or liquid Ca /Zn stabilizers.

Particularly preferred stabilizers that have shown good compatibility with the plasticizer of the present invention in a E-PVC for use in coating are listed in the table below.

| | | | |
|---|---|---|---|
| Trademark | Type | Form | Supplier |
| Reagens SLX/781 | Ba/Zn | Liquid | Reagens |
| Lankromark™ LZB1150 | Ba/Zn | Liquid | Valtris Specialty Chemicals |
| TS 221 | Ca/Zn | Liquid | AM Stabilizers |
| Lastab™ CF419 | Ca/Zn | Liquid | Valtris Specialty Chemicals |

In another embodiment of the present invention the polyvinyl chloride resin a) is an E-PVC and in order to reach a PVC composition having a high process stability in molding, suitable stabilizers c) are then liquid Ba/Zn stabilizers.

Particularly preferred stabilizers that have shown good compatibility with the plasticizer of the present invention in a E-PVC for use in molding are listed in the table below.

| | | | |
|---|---|---|---|
| Trademark | Type | Form | Supplier |
| Lankromark™ LZB1150 | Ba/Zn | Liquid | Valtris Specialty Chemicals |

The present invention also refers to a polyvinyl chloride article comprising a composition according to the invention and where the amount of free acid in said article is less than 30 ppm, preferably less than 20 ppm and most preferably less than 10 ppm.

The present invention further refers to the use of a S-PVC composition according to the invention, for making flooring, roof membranes or other outdoor applications, stationary, films and/or automotive applications.

For the use of a S-PVC composition of the present invention for making flooring, particularly preferred stabilizers are listed in the table below.

| | | | |
|---|---|---|---|
| Trademark | Type | Form | Supplier |
| Reagens SLX/781 | Ba/Zn | Liquid | Reagens |
| Naftosafe® PXX 30152 | OBS | Solid | Chemson |
| Naftosafe® HFP 86871 | OBS | Solid | Chemson |
| Mark® OBS 2405 | OBS | Liquid | Galata Chemicals |

For the use of a S-PVC composition of the present invention for making roof membranes or other outdoor applications, particularly preferred stabilizers are listed in the table below.

| | | | |
|---|---|---|---|
| Trademark | Type | Form | Supplier |
| Reagens SLX/782 F | Ba/Zn | Liquid | Reagens |
| Lankromark™ LZB1150 | Ba/Zn | Liquid | Valtris Specialty Chemicals |
| TS 510 with TS 511 | Ba/Zn | Liquid | AM Stabilizers |
| Naftosafe® PXX 30152 | OBS | Solid | Chemson |
| Naftosafe® HFP 86871 | OBS | Solid | Chemson |

For the use of a S-PVC composition of the present invention for making stationary, particularly preferred stabilizers are listed in the table below.

| | | | |
|---|---|---|---|
| Trademark | Type | Form | Supplier |
| Lankromark™ LZB1150 | Ba/Zn | Liquid | Valtris Specialty Chemicals |

For the use of a S-PVC composition of the present invention for making films, particularly preferred stabilizers are listed in the table below.

| | | | |
|---|---|---|---|
| Trademark | Type | Form | Supplier |
| Mark® OBS 2405 | OBS | Liquid | Galata Chemicals |

For the use of a S-PVC composition of the present invention for making automotive applications, particularly preferred stabilizers are listed in the table below.

| | | | |
|---|---|---|---|
| Trademark | Type | Form | Supplier |
| Reagens SLX/781 | Ba/Zn | Liquid | Reagens |
| Mark® 6092 ACM | Mg/Zn | Solid | Galata Chemicals |
| Mark® OBS 2405 | OBS | Liquid | Galata Chemicals |

The use of an E-PVC composition according to the invention, for making artificial leather, floor coverings, wall coverings, coated fabrics, car underbody coatings and/or toys or other rotational moulded articles is also included in the present invention.

For the use of an E-PVC composition of the present invention for making artificial leather, particularly preferred stabilizers are listed in the table below.

| | | | |
|---|---|---|---|
| Trademark | Type | Form | Supplier |
| Reagens SLX/781 | Ba/Zn | Liquid | Reagens |
| Mark® OBS 2405 | OBS | Liquid | Galata Chemicals |

For the use of an E-PVC composition of the present invention for making floor coverings, particularly preferred stabilizers are listed in the table below.

| | | | |
|---|---|---|---|
| Trademark | Type | Form | Supplier |
| TS 221 | Ca/Zn | Liquid | 100 |
| Mark® OBS 2405 | OBS | Liquid | Galata Chemicals |

For the use of an E-PVC composition of the present invention for making coated fabrics, particularly preferred stabilizers are listed in the table below.

| | | | |
|---|---|---|---|
| Trademark | Type | Form | Supplier |
| Reagens SLX/782 F | Ba/Zn | Liquid | Reagens |
| Lankromark™ LZB1150 | Ba/Zn | Liquid | Valtris Specialty Chemicals |
| TS 510 with TS 511 | Ba/Zn | Liquid | AM Stabilizers |
| Naftosafe® PXX 30152 | OBS | Solid | Chemson |
| Naftosafe® HFP 86871 | OBS | Solid | Chemson |

The composition of the present invention may also comprise other suitable additives, in addition to the ingredients above. For example lubricants, fillers, pigments, flame retardants, light stabilizers, blowing agents, polymeric processing aids and/or impact modifiers.

The composition according to the invention may be used for producing foams using blowing agents. For this purpose, chemical or physical blowing agents are preferably added to the composition. In plastisol foams, the stabilizer is often called a kicker and is added in order to regulate the decomposition temperature of the blowing agents.

The present invention is further explained with reference to enclosed embodiment Examples, which are to be construed as illustrative and not limiting in any way.

### EXAMPLES

Example 1 illustrates the synthesis of the plasticizer of the present invention: pentaerythritol tetravalerate,
Example 2 illustrates the preparation of a PVC composition of the present invention with S-PVC, processing and preparation of test samples,
Example 3 illustrates the preparation of a PVC composition of the present invention with E-PVC, processing and preparation of test samples,
Example 4 illustrates PVC compositions only comprising a stabilizer,
Example 5 illustrates PVC compositions comprising the combination of a stabilizer and an additive,
Example 6 illustrates the evaluation of obtained PVC test samples,
Example 7 illustrates the valeric acid analysis method.

### Example 1

### Synthesis of Pentaerythritol Tetravalerate

2 mole of pentaerythritol (having a purity of at least 98%, an ash content of less than 200 ppm and a dipentaerythritol content of 0.1-2 wt%), and 8 mole (+25% surplus) of valeric acid were charged into a glass reactor equipped with stirrer, condenser, nitrogen inlet and thermometer. 4% by weight of xylene was added as an azeotropic solvent. The mixture was heated under stirring to 220° C. Esterification water began to evaporate and when approximately 80% of a theoretical water amount had been collected the reaction mixture was cooled to 150° C. and 0.1% by weight of titanium(IV)isopropoxid (Tyzor TPT) was added as a catalyst. The mixture was subsequently heated to 220° C. and maintained until a desired acid number was reached and a theoretical water amount was collected, where after the reaction mixture was cooled and the solvent and unreacted valeric acid was removed under vacuum while slowly increasing the temperature to 180° C. After cooling, the solution was neutralised by addition of calcium hydroxide and a small amount of water, followed by vacuum distillation at 140° C. and filtration at room temperature. Pentaerythritol valerate with 97% tetra esterification and an acid value of less than 0.05 mg KOH/g was obtained.

### Example 2

### Preparation of a PVC Composition of the Present Invention with S-PVC

100 phr of a PVC homopolymer suspension resin powder (S-PVC) (Norvinyl S-7060, commercially available from Inovyn) was blended with 50 phr pentaerythritol tetravalerate obtained in Example 1, 2 phr of a selected stabilizer (as found in Table 1) and optionally a defined amount of an additive. The components were mixed at a temperature of about 80-90° C. for about 10 min, until the plasticizer was completely absorbed by the S-PVC polymer.

### Processing and Preparation of Test Samples

The S-PVC powder composition to be tested was then homogenized and gelated on a dual roller mill at a temperature of 165° C. for 5 minutes. Some rolls were stored in aluminium foil to be tested for storage stability 6 months later. The rest of the rolls were conditioned in a climate room (at 23° C. and 50% RH) and subsequently pressed at a temperature of 190° C. for 3 minutes to form smooth test films with a thickness of 1.3-1.4 mm. The hot samples were then placed between cooling plates and pressed at 20 bar until a temperature of 130° C. was reached. The samples were then cut into pieces of no less than 2 g each and sent to valeric acid analysis. The amount of valeric acid leaving the PVC composition during pressing was determined as a measure of process stability. The samples were then placed in a climate room ((at 23° C. and 50 % RH) for storage until the samples were subjected to a hydrolysis test were the concentration of valeric acid was measured. A long-term stability test was also performed, where the valeric acid concentration was measured after 6 months.

### Example 3

### Preparation of a PVC Composition of the Present Invention with E-PVC

100 phr of a PVC homopolymer emulsion resin (E-PVC) (Pevikon 2170, commercially available from Inovyn) was blended with 50 phr pentaerythritol tetravalerate obtained in Example 1, 2 phr of a selected stabilizer (as found in Table 1) and optionally a defined amount of an additive. The components were mixed at a temperature of about 80-90° C. until the plasticizer was completely absorbed by the E-PVC polymer, producing a plastisol paste.

### Processing and Preparation of Test Samples

A paper substrate was mounted in a frame and the frame was attached to the oven. A coating device (roll + doctors knife) on the Mathis equipment is used to coat the substrate with the plastisol. The wet thickness was 1-1.2 mm and the dry thickness was appr. 0.8-1 mm. The paste was coated on a paper to produce a film or a fabric to produce coated fabrics. The PVC paste was then fused in an oven with a curing time of 1,5 minutes at 190° C. and 1900 rpm fan speed.

The cured plastisol films were then analyzed for valeric acid concentration, tested for hydrolytic stability and long-term storage stability after 6 months. In order to measure the process stability the plastisol films were pressed at 100 bar and at a temperature of 190° C. for 2 minutes to form smooth test films with a thickness of 1.3-1.4 mm. The hot samples were then placed between cooling plates and pressed at 20 bar until a temperature of 130° C. was reached. The samples were then cut into pieces of no less than 2 g each and sent to valeric acid analysis. The amount of valeric acid leaving the PVC composition during pressing was determined as a measure of process stability. The samples were then placed in a climate room ((at 23° C. and 50 % RH) for storage until the samples were subjected to a hydrolysis test were the concentration of valeric acid was measured. A long-term stability test was also performed, where the valeric acid concentration was measured after 6 months.

### Example 4

### PVC Compositions Only Comprising a Stabilizer

PVC compositions A-L and Q-U in Table 1 are compositions only comprising a stabilizer and no additive. The ingredients of these compositions were mixed in amounts according to Table 1 and processed according to the procedure in Example 2 and 3. The amount of valeric acid was analyzed for the different samples at formation, during pressing and after long-term storage in order to measure the stability of the compositions. For compositions A-K the valeric acid concentration was also measured after hydrolysis testing. The stability criteria was evaluated in Example 6 and the result is reported in Table 2. Compositions A-K are compositions according to the invention and P-T are comparative compositions having a too high amount of valeric acid.

### Example 5

### PVC Compositions Comprising the Combination of a Stabilizer and an Additive

PVC compositions P-T comprising S-PVC, pentaerythritol tetravalerate from Example 1 and a stabilizer in amounts according to Table 1 were mixed, roll milled and pressed according to the procedure in Example 2. The amount of valeric acid in the samples after pressing was analyzed in order to assess the process stability of the compositions. The amount of valeric acid in the samples was also analyzed after 6 months in order to assess the storage stability. As can be seen from the results, reported in Table 2, the amount of valeric acid is too high for all of the compositions, except for compositions S and T that have storage stability.

In the compositions (P-R) comprising a liquid Ca/Zn stabilizer and the composition S comprising a solid Ca/Zn stabilizer, a liquid calcium overbased additive (PlastiStab 2266 from AM Stabilizers) was added in amounts according to Table 1 (composition L-O). The new compositions (L-O) comprising a stabilizer and an overbased additive were mixed, roll milled and pressed according to the procedure in Example 2 and the amount of valeric acid after pressing was analyzed. As can be seen from the results, reported in Table 2, the amount of valeric acid is considerably lowered by the presence of the overbased additive. The amount of valeric acid in composition L-O are low enough to reach the process stability criteria of less than 30 ppm.

By the addition of the calcium overbased additive, the degradation of pentaerythritol tetravalerate induced by the presence of the Ca/Zn stabilizer is reduced in comparison to the compositions without said additive. The result shows an increased process stability and storage stability by the addition of the calcium overbased additive.

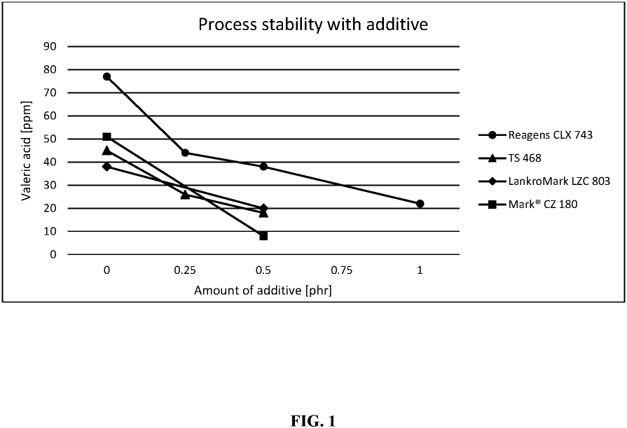

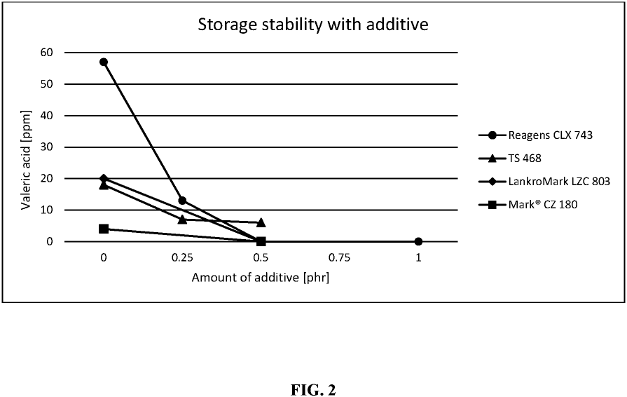

For compositions comprising a solid Ca/Zn stabilizer a calcium overbased additive could increase the process stability. For compositions comprising a liquid Ca/Zn stabilizer both the process stability and the storage stability can be increased by the addition of a calcium overbased additive. As can be seen from FIGS. 1 and 2, amounts of 0.25-1 phr of the additive seems to be suitable, depending on the valeric acid concentration of the composition without additive addition.

### Example 6

### Evaluation of Obtained PVC Test Samples

The stability of the compositions A-T was evaluated in terms of valeric acid concentration, determined in the produced PVC film by a new method developed to be able to analyze low amounts of valeric acid in PVC films with Liquid Chromatography (LC) after derivatization of the acid to an amide, see Example 7.

The process stability was evaluated by measuring the amount of valeric acid leaving the PVC compositions during pressing. In order for a composition to be considered as process stable, the amount of valeric acid must not be more than 30 ppm, preferably not more than 20 ppm and most preferably not more than 10 ppm.

The storage stability was evaluated by measuring the amount of valeric acid in the formed PVC samples and then after 6 months of storage in a climate room (at 23° C. and 50 % RH). The difference in valeric acid concentration must not have increased more than 15 ppm in order for a composition to have storage stability. In some cases the compositions have a negative value for storage stability, indicating a decline in the amount of valeric acid. The reason for this could be that free valeric acid is absorbed by the stabilizer or the additive. For instance zeolites seem to have the ability to absorb valeric acid.

Hydrolytic stability was evaluated by exposing the PVC samples to near 100 % RH and 50° C. for 3 weeks and then measuring the amount of valeric acid. The valeric acid concentration must not be more than 150 ppm in order for a composition to be considered as hydrolytic stable.

Process stability, storage stability and hydrolytic stability were evaluated for compositions A-K and the results are presented in Table 2. All of these compositions did meet the stability criteria. Compositions L-T were evaluated for process stability and storage stability. Compositions P-T did not have enough process stability only comprising a stabilizer. With effective amounts of an additive present the compositions L-O did reach an acceptable process stability. Regarding storage stability, compositions P-R comprising a liquid Ca/Zn stabilizer were not stable enough, but obtained storage stability with the addition of a liquid calcium overbased additive. Composition S comprising a solid Ca/Zn stabilizer is storage stable, but the storage stability is further increased with the addition of a liquid calcium overbased additive (composition O).

### Example 7

### Valeric Acid Analysis Method

Valeric acid was extracted from 0.5 mg PVC cut into small pieces in 1 ml acetonitrile during 30 min on ultrasonic bath. The amount of valeric acid was then determined with liquid chromatography after derivatization of the acid with a carbodiimide and an amine.

The carbodiimide used was 1-ethyl-3-(3-dimethylaminopropyl) carbodiimide (EDC) and the amine was 2-nitrophenylhydrazine (2-NPH). EDC first reacted with valeric acid to form an O-acylisourea intermediate and the intermediate then reacted with 2-NPH to form an amide derivative of the acid and an urea, according to the reaction scheme below:

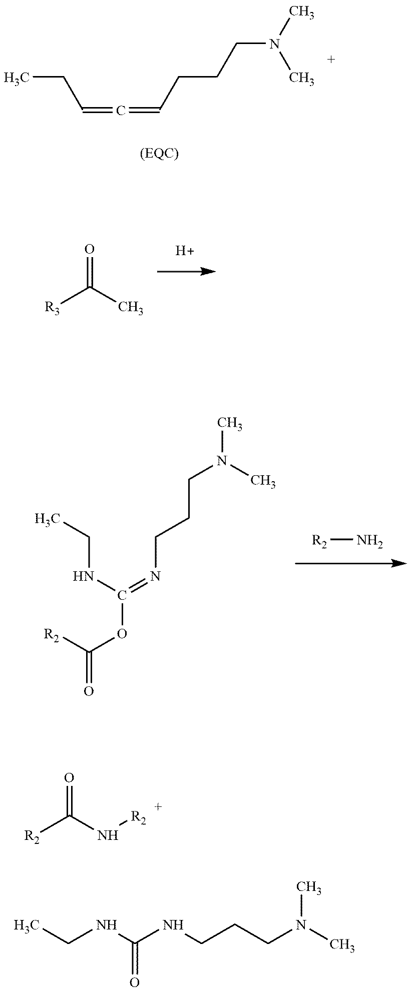

The amide derivative of the acid was then analyzed with liquid chromatography in order to determine the amount of valeric acid in the PVC sample. The result of the different valeric acid measurements is reported in table 2. The detection limit of this method is 0.2 ppm.

Table 1

| Compositions | | | Campositions of the invention | | | | | | | | | | | | | | | Comparative compositions | | | | |
|---|---|---|---|---|---|---|---|---|---|---|---|---|---|---|---|---|---|---|---|---|---|---|
| | | | A | B | C | D | E | F | G | H | I | J | K | L | M | N | O | P | Q | R | S | T |
| PVC | Norvinyl S-7060 | S-PVC | 100 | 100 | | 100 | | | 100 | 100 | | | 100 | 100 | 100 | 100 | 100 | 100 | 100 | 100 | 100 | 100 |
| | Pevikon 2170 | E-PVC | | | 100 | | 100 | 100 | | | 100 | 100 | | | | | | | | | | |
| Plasticizer | Pentaerythritol tetravalerate | | 50 | 50 | 50 | 50 | 50 | 50 | 50 | 50 | 50 | 50 | 50 | 50 | 50 | 50 | 50 | 50 | 50 | 50 | 50 | 50 |
| Stabilizer | LankroMark™ LZB985 | Ba/ZN L | 2 | | | | | | | | | | | | | | | | | | | |
| | LankroMark™ LZ81150 | Ba/Zn L | | 2 | | | | | | | | | | | | | | | | | | |
| | Reagens SLX 782 F | Ba/Zn L | | | 2 | | | | | | | | | | | | | | | | | |
| | Mark* 4825 | Ba/Zn L | | | | 2 | | | | | | | | | | | | | | | | |
| | TS 221 | Ca/Zn L | | | | | 2 | | | | | | | | | | | | | | | |
| | Lastab™ CF419 | Ca/Zn L | | | | | | 2 | | | | | | | | | | | | | | |
| | Lastab™ CF375T | Ca/Zn L | | | | | | | 2 | | | | | | | | | | | | | |
| | Mark* OBS 2405 | OBS L | | | | | | | | 2 | | | | | | | | | | | | |
| | Naftosafe® PXX 30152 | OBS S | | | | | | | | | 2 | | | | | | | | | | | |
| | Naftosafe® HFP 86871 OBS | OBS S | | | | | | | | | | 2 | | | | | | | | | | |
| | Reapak 8-NT/7056 3X | OBS S | | | | | | | | | | | 2 | | | | | | | | | |
| | Reagens CLX 743 | Ca/Zn L | | | | | | | | | | | | 2 | | | | 2 | | | | |
| | T5 468 | Ca/Zn L | | | | | | | | | | | | | 2 | | | | 2 | | | |
| | LankroMark™ L2C 803 | Ca/Zn L | | | | | | | | | | | | | | 2 | | | | 2 | | |
| | Mark* CZ 180 | Ca/Zn S | | | | | | | | | | | | | | | 2 | | | | 2 | |
| | Lastab™CE 706PF | Ca/Zn L | | | | | | | | | | | | | | | | | | | | 2 |
| Additive | Plastistab 2265 | Ca O8^{®} L | | | | | | | | | | | | 1 | 0.5 | 0.5 | 0.5 | | | | | |

*OB= overbased

Table 2

| Stabilities | | Limit value | Compositions of the invention | | | | | | | | | | | | | | | Comparative compositions | | | | |
|---|---|---|---|---|---|---|---|---|---|---|---|---|---|---|---|---|---|---|---|---|---|---|
| | | | A | B | C | D | E | F | G | H | I | J | K | L | M | N | O | P | Q | R | S | T |
| Process stability | Veleric acid (ppm) | 30 | 29 | 15 | 12 | 21 | 12 | 6 | 7 | 0.9 | 7 | 9.5 | 7.7 | 22 | 18 | 20 | 8 | 77 | 45 | 38 | 51 | 93 |
| Storage stability | Change in Valeric acid after 6 months (ppm) | <15 | 0 | 15 | 1.0 | 0.5 | 0 | 0.8 | 0.3 | 0.2 | 1.0 | 1.6 | 3.5 | 0 | 6 | 0 | 0 | 57 | 18 | 20 | 4 | 0 |
| Hydrolytic stability | Valeric acid (ppm) | 150 | 76 | 100 | 93 | 96 | 38 | 66 | 96 | 28 | 19 | 26 | 29 | | | | | | | | | |

1. A polyvinyl chloride composition with high stability comprising:
(a) 100 phr (parts per hundred resin) of a polyvinyl chloride resin,
(b) 10-150 phr of pentaerythritol tetravalerate as plasticizer, the pentaerythritol tetravalerate having an acid value of less than 0.05 mg KOH/g and obtained through esterification of valeric acid and high purity pentaerythritol having a purity of at least 98%, an ash content of less than 200 ppm, and a dipentaerythritol content of 0.1-2 wt%,
(c) 0.3-14 phr of at least one stabilizer, and
(d) optionally, at least one additive,
wherein the high stability is defined as an amount of free acid in the polyvinyl chloride composition being less than 30 ppm of free acid.

2. The composition according to claim 1, wherein the amount of free acid in the polyvinyl chloride composition is less than 20 ppm.

3. The composition according to claim 1, wherein the high purity pentaerythritol has an ash content of less than 50 ppm.

4. The composition according to claim 1, wherein the stabilizer (c) is present in an amount of 1-6 phr.

5. The composition according to claim 1 having a high process stability, wherein the stabilizer (c) is selected from the liquid Ba/Zn, liquid Ca/Zn, solid Ca/Zn, liquid organic based (OBS), and solid organic based (OBS) and the optional additive (d) is selected from the carbodiimide, epoxidized soybean oil (ESO), epoxidized linseed oil (ELO), amine, phosphite, overbased carboxylate, overbased sulfonate, overbased phosphonate, overbased salicylate, overbased phenate including Ca, Ba or Mg, oxazolidine, zeolite, hydrotalcite, calcium oxide, and calcium hydroxide, wherein the high process stability is defined as not more than 30 ppm of acid leaving the composition during processing.

6. The composition according to claim having a high storage stability, wherein the stabilizer (c) is selected from the liquid Ba/Zn, liquid Ca/Zn, solid Ca/Zn, liquid organic based (OBS), solid organic based (OBS), and solid Mg/Zn and the optional additive (d) is selected from carbodiimide, overbased carboxylate, overbased sulfonate, overbased phosphonate, overbased salicylate. overbased phenate including Ca, Ba or Mg, zeolite, hydrotalcite, calcium oxide, and calcium hydroxide, wherein the high storage stability is defined as a concentration of free acid not increasing more than 15 ppm during 6 months of storage.

7. The composition according to claim 1 having a high hydrolytic stability, wherein the stabilizer (c) is selected from Ba/Zn, liquid Ca/Zn, solid Ca/Zn, paste Ca/Zn, liquid organic based (OBS), and solid organic based (OBS) and the optional additive (d) is a carbodiimide, polymeric primary epoxide and/or a zeolite, wherein the high hydrolytic stability is defined as a concentration of free acid not being more than 150 ppm after 3 weeks of exposure to near 100 % RH and 50° C.

8. The composition according to claim 1 having a combination of high process stability, high storage stability, and high hydrolytic stability, wherein the stabilizer (c) is selected from liquid Ba/Zn, liquid Ca/Zn, and liquid organic based and solid organic based stabilizers and the optional additive (d) is a carbodiimide, polymeric primary epoxide, and/or a zeolite.

9. The composition according to claim 1, wherein the polyvinyl chloride resin (a) is a polyvinyl chloride suspension resin (S-PVC).

10. The composition according to claim 9, wherein the stabilizer (c) is selected from liquid Ba/Zn, solid Ca/Zn, and liquid calcium organic based stabilizers.

11. (canceled)

12. (canceled)

13. (canceled)

14. The composition according to claim 1, wherein the polyvinyl chloride resin (a) is a polyvinyl chloride emulsion resin (E-PVC).

15. The composition according to claim 14, wherein the stabilizer (c) is selected from liquid Ba/Zn, liquid Ca/Zn, and liquid calcium organic based stabilizers, and wherein the composition is a plastisol.

16. The composition according to claim 5, wherein the polyvinyl chloride resin (a) is a polyvinyl chloride emulsion resin (E-PVC) and the stabilizer (c) is a liquid Ba/Zn and/or a liquid Ca/Zn stabilizer, and wherein the composition is a coating.

17. (canceled)

18. A polyvinyl chloride article comprising the composition according to claim 1, wherein the amount of free acid in the article is less than 30 ppm.

19. A method for analyzing the amount of free acid in a polyvinyl chloride composition according to claim 1 comprising extracting the acid from the polyvinyl chloride composition, derivatizing the acid with a carbodiimide and an amine, and determining the amount of amide by liquid chromatography.

20. The method according to claim 19, wherein the acid is extracted from the polyvinyl chloride composition in an ultrasonic bath with acetonitrile.

21. The method according to claim 19, wherein the carbodiimide is 1-ethyl-3-(3-dimethylaminopropyl) carbodiimide (EDC) and the amine is 2-nitrophenyl-hydrazine (2-NPH).

22. The method according to claim 19, wherein the acid is valeric acid.

23. The article of claim 18, wherein the article is selected from flooring, roof membranes or other outdoor applications, stationary, films, and/or automotive applications.

24. The article of claim 18, wherein the article is selected from artificial leather, floor coverings, wall coverings, coated fabrics, car underbody coatings and/or toys or other rotational moulded articles.
